(19) United States
(12) Patent Application Publication
(10) Pub. No.: US 2004/0148060 A1
(43) Pub. Date: Jul. 29, 2004

(54) Method and device for power management and control of power supply system

(76) Inventor: Rong-Jung Lee, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/418,083

(22) Filed: Apr. 18, 2003

(30) Foreign Application Priority Data
Jan. 24, 2003 (TW) 92101576

(51) Int. Cl. G05D 17/00

(52) U.S. Cl. 700/295

(57) ABSTRACT

A power management system includes a switching unit connected between an external power source and a number of loads of an electronic system and includes a number of switching element respectively and selectively supplying electrical power to each of the loads. A control unit controls the operation of the switching unit to selectively supply electrical power to the loads. The control unit operates in such a way to sequentially shut down the loads in accordance with a predetermined priority sequence when an actual output current from the external power source exceeds a predetermined threshold and to sequentially resume the operation of the loads that are previously shut down in a reversed sequence when the actual output current of the external power source gets below the threshold.

### BACKGROUND OF THE INVENTION

1. Field of the Invention

The present invention relates generally to power management and control for power supply systems, and in particular to a power management and control technique for effectively handling overloading and over-current of the power supply systems.

2. Description of the Prior Art

In modern society, electronic devices are indispensable installation for efficient processing of work or communication. Electronic devices, such as notebook computers, are powered by electricity. The more powerful the electronic device is, the more electrical power it consumes in operation. Accordingly, a power supply system is required for timely and sufficient supply of electricity.

In early days, the primary and sole function of a power supply system is to supply a stable power, and the management of power supply system was not demanded. Power supply system commonly comprises a fuse for protection of the electronic device from damage by cutting off power supply in case of electrical overloading.

However, such a simple power supply system no longer meets with and is not feasible nowadays for the current electronic devices which require temporary storage of signals or data generated during the operation thereof. Although using an oversized power supply can solve the mentioned problem, cost is expensive. Moreover, the technology advancement and information development has created new demand for other functions e.g. power management to a power supply system in addition to supplying power.

Power supply systems with power management for reducing unnecessary power consumption are also known and frequently employed in portable electronic devices that have a limited supply of electrical power from an internal power source. For example, a notebook computer may enter a suspended mode after the notebook computer has been in idle state for a predetermined period of time. Some peripheral devices of the notebook computer, such as a display panel and disk drives, are turned off for saving power. This technique is capable to reduce power consumption, but cannot handle overloading problem or control of current flowing through loads.

Thus, the present invention is aimed to manage power supply in an efficient manner in order to overcome the above problems.

### SUMMARY OF THE INVENTION

Thus, a primary object of the present invention is to provide a method and device associated therewith for power management and control of power supply, such that when detecting an over-current condition, power supply to some of the loads of an electronic system is temporarily cut off, and full power supply is then resumed when the over-current vanishes.

Another object of the present invention is to provide a method and device associated therewith for power management and control of power supply, such that when detecting an overloading condition of the power supply system, power supply to some loads of an electronic system is sequentially cut off in accordance with predetermined priority in order to reduce the loading to an acceptable value and the power supply is then resumed in a reversed sequence when the overloading condition vanishes.

To achieve the above objects, in accordance with the present invention, a switching unit is connected between an external power source and a number of loads of an electronic system and includes a number of switching elements respectively and selectively supplying electrical power to each of the loads. A control unit controls the operation of the switching unit to selectively supply electrical power to the loads. The control unit operates in such a way to sequentially shut down the loads in accordance with a predetermined priority sequence when an actual output current from the external power source exceeds a predetermined threshold and to sequentially resume the operation of the loads that are previously shut down in a reversed sequence when the actual output current of the external power source gets below the threshold. Thus, operation save of the electronic system receiving electrical power from the external power source via the switching unit can be ensured.

### BRIEF DESCRIPTION OF THE DRAWINGS

The present invention will be apparent to those skilled in the art by reading the following description of the best mode and a preferred embodiment of a device for carrying out the present invention, with reference to the attached drawings, in which:

FIG. 1 is a system block diagram of a power management and control device in accordance with the present invention;

FIG. 2 is a flow chart for performing a method of power management and control in accordance with a first embodiment of the present invention; and

FIG. 3 is a flow chart for performing a method of power management and control in accordance with a second embodiment of the present invention.

### DETAILED DESCRIPTION OF THE PREFERRED EMBODIMENTS

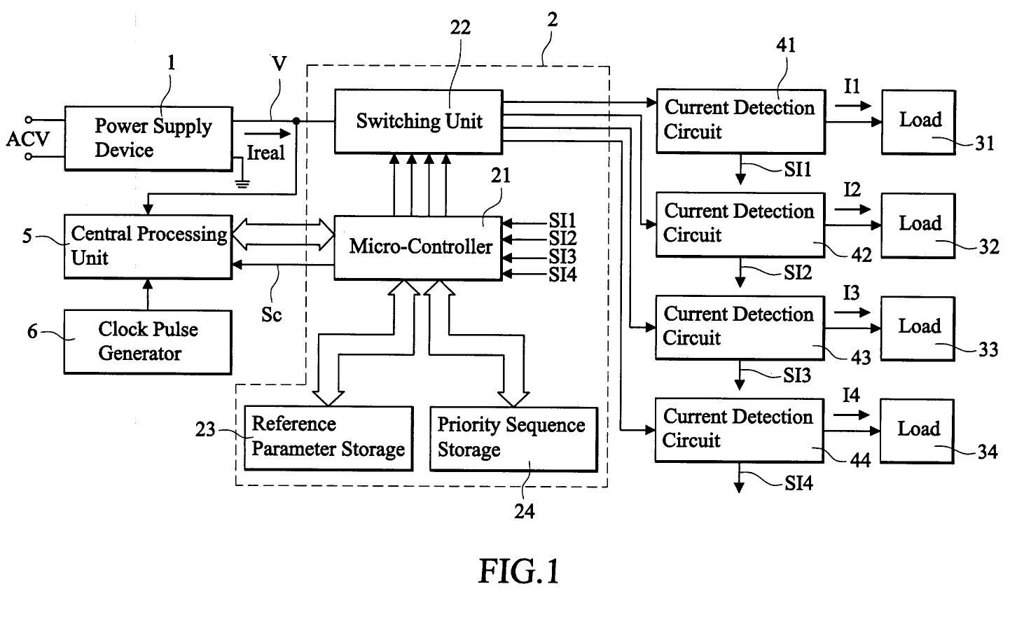

With reference to the drawings and in particular to FIG. 1, a power supply device 1 is connected to an external power source ACV for receiving an alternating current from the external power source ACV and in turn supplying a direct current (DC) of voltage V. The DC voltage V is supplied to a number of loads 31, 32, 33, 34, which may totally constitute an electronic device or an electronic system, such as a notebook computer and a desktop computer, via a control device 2 which is capable of selectively supplying electrical power to each of the loads 31, 32, 33, 34.

The power supply device 1 has a maximum rated output voltage Vmax and a maximum rated output current Imax. In actual operation, the power supply device 1 supplies a current Ireal that is the sum of the currents I1, I2, I3, I4 flowing through all the loads 31, 32, 33, 34. The control device 2 is capable to detect the load currents I1, I2, I3, I4 and determines power consumption of each load 31, 32, 33, 34. Also the control device 2 is capable to determine the overall current Ireal from the power supply device 1 by summing up all the load currents I1, I2, I3 and I4.

A current detection circuit 41, 42, 43, 44 is connected between each load 31, 32, 33, 34 and the control device 2 for detection of the load current I1, I2, I3, I4 supplied to the 31, 32, 33, 34 respectively. The current detection circuits 41, 42, 43, 44 provide current signals S11, S12, S13, S14 respectively representing the load current I1, I2, I3, I4 to the control device 2. The control device 2 operates in accordance with the current signals S11, S12, S13, S14 to control the load current I1, I2, I3, I4 flowing through the loads 31, 32, 33, 34. The control device 2 comprises a micro-controller or microprocessor-based device 21 to which a switching unit 22 is coupled. The switching unit 22 comprises a number of switching elements (not shown) respectively coupled to the loads 31, 32, 33, 34 for selectively supplying electrical power to the loads 31, 32, 33, 34 and/or cutting off the power supply. The micro-controller 21 is provided with data input port for receiving the current signals S11, S12, S13, S14 generated by the current detection circuits 41, 42, 43, 44.

The power supply device 1 can be any know power supply, such as a switching power supply that is commonly used in commercial computer system. In the case of notebook computers, the micro-controller 21 of the control device 2 can be embodied in a keyboard controller of the notebook computer. The micro-controller 21 is thus connected to a central processing unit 5 of the notebook computer via buses. The central processing unit 5 works under a clock signal provided by a clock generator 6 of the notebook computer. The micro-controller 21 of the control device 2 is also coupled to the central processing unit 5 via a control line along which an underclocking control signal Sc that is provided by the micro-controller 21 is transmitted. The underclocking control signal Sc switches the central processing unit 5 between an underclocked condition and a regularly clocked condition. In an underclocked condition, the central processing unit 5 operates with a frequency lower than regular working frequency and thus reducing power consumption thereof.

The control device 2 comprises a reference parameter storage unit 23 that is connected to the micro-controller 21. The reference parameter storage unit 23 stores reference values of a number of parameters, such as the rated output current Imax, the rated output voltage Vmax, the rated current for each load, and other data. A current margin Idiff, which is an acceptable margin difference between the rated output current Imax and the actual output current Ireal, is also stored in the reference parameter storage unit 23.

The control device 2 also comprises a priority sequence storage unit 24, also connected to the micro-controller 21 and in which the number of the loads and a sequence of priority for sequentially cutting off power supplied to the loads 31, 32, 33, 34 are stored. For example, in the application of notebook computers, a load that has the first priority for power cut off is a battery charging circuit of the notebook computer. In other words, in case of insufficiency of power supply, the electrical power supplied to charge the battery of the notebook computer is cut off first. Other loads, including both physical loads, such as battery, fan, and disk drive and functions and/or programs selectively performed by the notebook computer, such as underclocking of the central processing unit, may be arranged in a priority list in accordance with their importance to the overall performance of the notebook computer. For example, stopping charging the battery normally does not affect the operation performance of the notebook computer at all and underclocking the central processing unit does not significantly affect the performance of the notebook computer. The priority list is stored in the priority sequence storage unit 24 based on which the micro-controller 21 shuts down or cuts off power supply to the “loads” and/or gives instruction to continue/discontinue the “functions” and/or “programs” performed by the device.

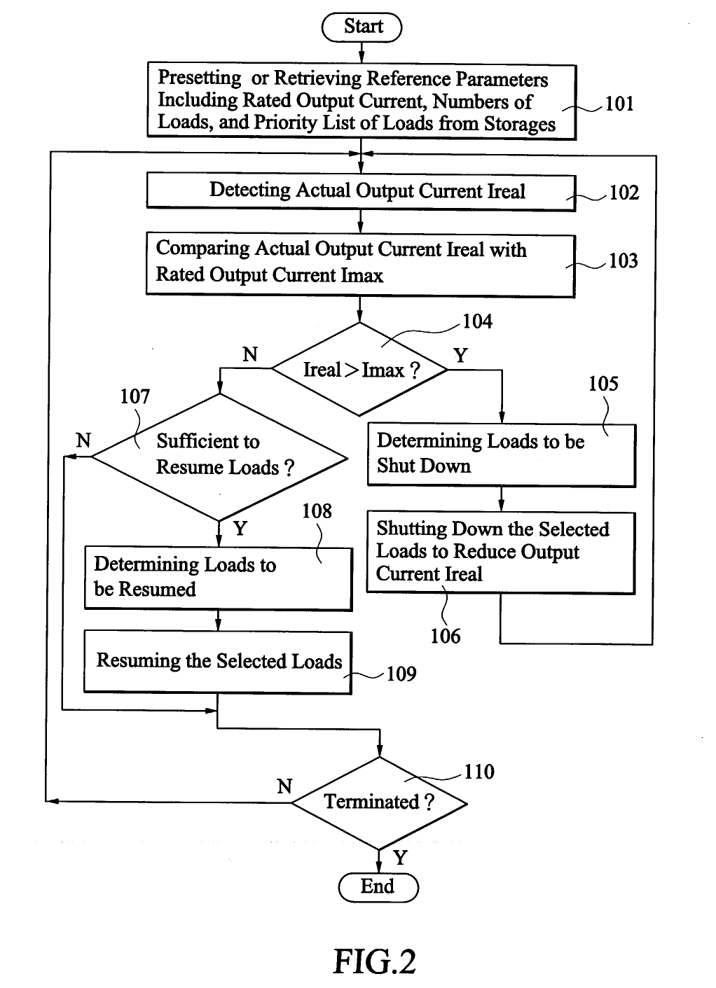

With the control device 2, the present invention performs a method for power management and control of the power supply device 1. FIG. 2 shows a flow chart of the method in accordance with a first embodiment of the present invention, including presetting or retrieving the reference values of the parameters e.g. rated output current Imax of power supply device 1 and the number of loads stored in the reference parameter storage unit 23 and the priority list stored in the priority sequence storage unit 24 in step 101.

In step 102, the control device 2 detects and determines the actual output current Ireal of the power supply device 1 and in step 103, the actual output current Ireal is compared with the rated output current Imax of the power supply device 1. A determination making step, step 104, is then performed. In case the actual output current Ireal exceeds the rated output current Imax, the control device 2 calculates and determines how many and which of the loads 31, 32, 33, 34 are to be shut down in order to reduce the actual output current to a value smaller than the rated output current, step 105.

In step 106, the selected loads that are to be shut down for reducing actual output current Ireal are shut down in accordance with the priority list retrieved from the priority sequence storage unit 24. Once this is done, the process goes back to step 102 to detect the actual output current Ireal again for confirmation of the result of reducing the actual output current.

If underclocking the central processing unit is one of the items in the priority list, then the central processing unit is underclocked, in step 106, in accordance with the priority thereof in the list stored in the priority sequence storage unit 24.

In case the actual output current Ireal does not exceed the rated output current Imax in step 104, the control device 2 calculates the difference therebetween and determines if the difference is sufficient to resume the loads that were previously shut down, step 107. If the difference is insufficient to resume the loads that are previously shut down, then the process goes to step 110 to check if the process is manually terminated. If no termination instruction is received, the process goes back to step 102 to detect the actual output current Ireal again.

If the difference between the rated output current Imax and the actual output current Ireal is sufficient to resume some of the loads that are previously shut down, then the control device 2 determines how many and which of the loads that are previously shut down are to be resumed, step 108, and resume the operation of the loads in a reversal sequence in accordance with the priority list of the storage 24, step 109. Thereafter, the check of termination instruction is done in step 110 and the process either goes back to step 102 to detect the actual output current Ireal again or is terminated.

If underclocking of the central processing unit is included in the priority list for shutting down the loads, then the central processing unit 5 may be returned to the regular working frequency in accordance with the priority thereof when the output current of the power supply device 1 is sufficient to support it.

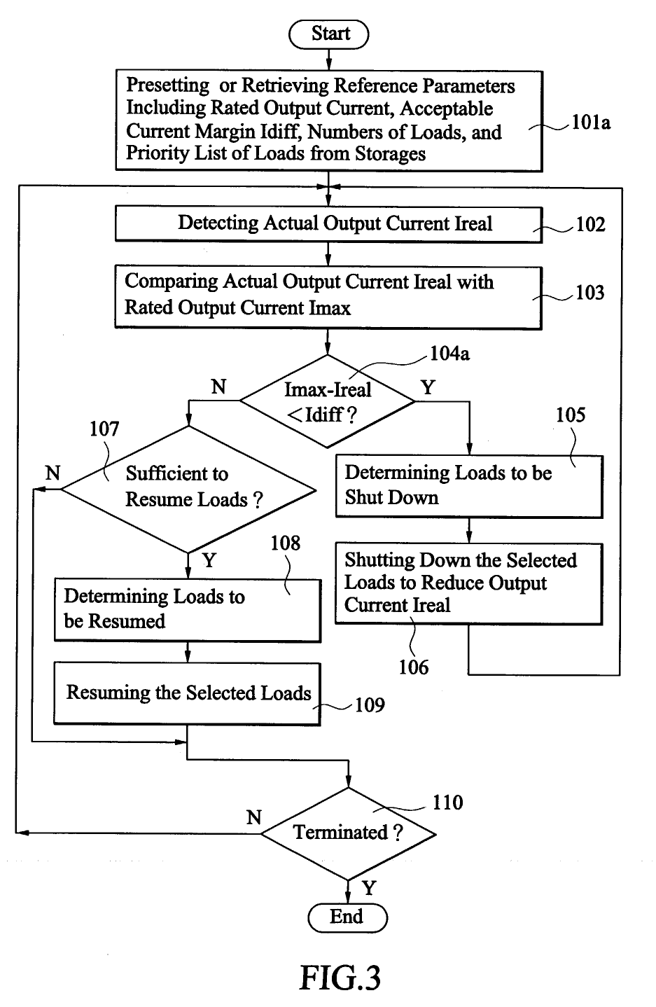

FIG. 3 shows a flow chart of a modified method in accordance with a second embodiment of the present invention, which is substantially identical to the flow chart of FIG. 2 whereby similar steps bear the same reference numeral as that of FIG. 2.

In step 101a, the reference values of the parameters including rated output current Imax of power supply device 1 and the number of loads stored in the reference parameter storage unit 23 and the priority list stored in the priority sequence storage unit 24 are preset or retrieved by the control device 2. In addition, an acceptable current margin Idiff is preset or retrieved from the reference parameter storage unit 23.

In step 102, the control device 2 detects and determines the actual output current Ireal of the power supply device 1 and in step 103, the actual output current Ireal is compared with the rated output current Imax of the power supply device 1. A determination making step, step 104a, is then performed to determine if the difference between the rated output current Imax and the actual output current Ireal is smaller than the acceptable current margin Idiff. In case the difference between the rated output current Imax and the actual output current Ireal is smaller than the acceptable current margin Idiff, the control device 2 calculates and determines which of the loads 31, 32, 33, 34 are to be shut down in order to make the difference between the rated output current Imax and the actual output current Ireal larger than the acceptable current margin Idiff, step 105. In step 106, the loads that are to be shut down for enlarging the difference between the rated outputs current Imax and the actual output current Ireal are shut down in accordance with the priority list retrieved from the priority sequence storage unit 24. Once this is done, the process goes back to step 102 to detect the actual output current Ireal again for confirmation of the result of enlarging the difference between the rated output current Imax and the actual output current Ireal.

In case the difference between the rated output current Imax and the actual output current Ireal exceeds the acceptable current margin Idiff in step 104a, the control device 2 determines if the difference is sufficient to resume some of the loads that were previously shut down without making the difference between the rated output current Imax and the actual output current Ireal smaller than the acceptable current margin Idiff, step 107. If the difference is insufficient to resume the loads that are previously shut down, then the process goes to step 110 to check if the process is manually terminated. If no termination instruction is received, the process goes back to step 102 to detect the actual output current Ireal again.

If the difference between the rated output current Imax and the actual output current Ireal exceeds the acceptable current margin Idiff with an amount that is sufficient to resume some of the loads that are previously shut down, then the control device 2 determines how many and which of the loads that are previously shut down are to be resumed, step 108, and resume the operation of the loads in a reversal sequence in accordance with the priority list of the storage 24, step 109. Thereafter, the check of termination instruction is done in step 110 and the process either goes back to step 102 to detect the actual output current Ireal again or is terminated.

It is apparent that electrical power supplied to an electronic system comprising a number of loads can be effectively maintained within a safety range without any overloading or over-current condition by timely and sequentially shutting down some of the loads that are less important to the performance of the electronic system. Thus, when the electronic system requires a total current from an power source is greater than a predetermined threshold that can be determined according to the rating value of the electronic system and the power source, the current that flows from the power source is effectively reduced by shutting down some of the loads. The operation safety is thus ensured.

Although the present invention has been described with reference to the best mode and the preferred embodiment thereof, it is apparent to those skilled in the art that a variety of modifications and changes may be made without departing from the scope of the present invention which is intended to be defined by the appended claims.

What is claimed is:

1. A power management and control method for a power supply system that supplies an electrical power to a plurality of loads, the method comprising the following steps:
(a) setting a reference for an output current of the power supply system and a priority sequence of shutting down the loads;
(b) detecting an actual output current supplied from the power supply system to the loads;
(c) comparing the actual output current with the reference output current;
(d) shutting down at least one of the loads in accordance with the priority sequence when the actual output current exceeds the reference output current in order to reduce the actual output current to a value smaller than the reference output current; and
(e) resuming the loads that are previously shut down in sequence opposite to the priority sequence when the actual output current gets smaller than the reference output current.

2. The method as claimed in claim 1, wherein the step of detecting the actual output current comprises detecting a current flowing through each load.

3. The method as claimed in claim 1, wherein the loads comprise a plurality of physical loads of a computer system.

4. The method as claimed in claim 1, wherein the loads comprise a plurality of functions and programs executed in a computer system.

5. The method as claimed in claim 1, wherein step (d) comprises a step of setting at least one selected load at an underclocking condition and step (e) comprises a step of resuming the selected load at a regular clocking condition.

6. A power management and control method for a power supply system that supplies an electrical power to a plurality of loads, the method comprising the following steps:
(a) setting a first reference for an output current of the power supply system, a second reference for a current margin, and a priority sequence of shutting down at least one of the loads, in which the current margin is an acceptable margin difference between the reference output current and the actual output current;
(b) detecting an actual output current supplied from the power supply system to the loads;
(c) comparing the actual output current with the reference output current;
(d) shutting down at least one of the loads in accordance with the priority sequence when the actual output current reaches a value such that a difference between the reference output current and the value of the actual output current is smaller than the reference current margin, in order to reduce the actual output current; and
(e) resuming the loads that are previously shut down in sequence opposite to the priority sequence when the difference between the reference output current and the value of the actual output current gets greater than the reference current margin.
(e) when the actual output current gets smaller than the reference output current.

7. The method as claimed in claim 6, wherein the step of detecting the actual output current comprises detecting a current flowing through each load.

8. The method as claimed in claim 6, wherein the loads comprise a plurality of physical loads of a computer system.

9. The method as claimed in claim 6, wherein the loads comprise a plurality of functions and programs executed in a computer system.

10. The method as claimed in claim 6, wherein step (d) comprises a step of setting at least one selected load at an underclocking condition and step (e) comprises a step of resuming the selected load at a regular clocking condition.

11. A power management and control device for a power supply system that supplies an electrical power to a plurality of loads constituting a load system, the device comprising:
a switching unit selectively supplying the electrical power to the loads;
a control unit coupled to and controlling the switching unit in selectively supplying the electrical power to the loads;
a first storage unit coupled to the control unit and containing a reference for an output current of the power supply system; and
a second storage unit coupled to the control unit and containing a sequence of priority for shutting down at least one load;
wherein the control unit detects an actual output current of the power supply system supplied to the loads and compares the actual output current with the reference output current for shutting down at least one of the loads in accordance with the priority sequence when the actual output current exceeds the reference output current and wherein the control unit resumes the loads that are previously shut down in sequence opposite to the priority sequence when the actual output current gets smaller than the reference output current.

12. The device as claimed in claim 11, wherein the priority is determined in accordance with importance of the loads with respect to performance of the load system.

13. The device as claimed in claim 11, wherein the load system comprises a notebook computer.

14. The device as claimed in claim 13, wherein the control unit comprises a keyboard controller of the notebook computer.

15. The device as claimed in claim 11, further comprising a plurality of current detection circuits coupled between the switching unit and the loads respectively for detecting current flowing through each load.

16. The device as claimed in claim 11, wherein the loads to be shut down and listed in the priority sequence stored in the second storage unit comprises underclocking at least one load of the load system.

17. A power management and control device for a power supply system that supplies an electrical power to a plurality of loads constituting a load system, the device comprising:
a switching unit selectively supplying the electrical power to the loads;
a control unit coupled to and controlling the switching unit in selectively supplying the electrical power to the loads;
a first storage unit coupled to the control unit and containing a first reference for output current of the power supply system and a second reference for a current margin which is an acceptable marginal difference between the reference output current and the actual output current; and
a second storage unit coupled to the control unit and containing a sequence of priority for shutting down at least one load;
wherein the control unit detects an actual output current of the power supply system supplied to the loads, calculates a difference between the reference output current and the actual output current and compares the difference with the reference current margin for shutting down at least one of the loads in accordance with the priority sequence when the difference is smaller than the reference current margin and wherein the control unit resumes the loads that are previously shut down in sequence opposite to the priority sequence when the difference gets larger than the reference current margin.

18. The device as claimed in claim 17, wherein the priority is determined in accordance with importance of the loads with respect to performance of the load system.

19. The device as claimed in claim 17, wherein the load system comprises a notebook computer.

20. The device as claimed in claim 19, wherein the control unit comprises a keyboard controller of the notebook computer.

21. The device as claimed in claim 17 further comprising a plurality of current detection circuits coupled between the switching unit and the loads respectively for detecting current flowing through each load.

22. The device as claimed in claim 17, wherein the loads to be shut down and listed in the priority sequence stored in the second storage unit comprises underclocking at least one load of the load system.
